(19) United States
(12) Patent Application Publication
(10) Pub. No.: US 2009/0043917 A1
(43) Pub. Date: Feb. 12, 2009

(54) Electronic Circuit and Method for Selecting an Electronic Circuit

(76) Inventor: Thilo Wagner, Dresden (DE)

Correspondence Address: SLATER & MATSIL, L.L.P., 17950 PRESTON ROAD, SUITE 1000, DALLAS, TX, 75252, US

(21) Appl. No.: 11/834,421

(22) Filed: Aug. 6, 2007

(51) Int. Cl. G06F 3/00

(52) U.S. Cl. 710/11

(57) ABSTRACT

An electronic circuit includes an input for receiving at least one input information item, the at least one input information item representing received encoded chip select information. The electronic circuit further includes a value modifier for providing modified encoded chip select information based on the received encoded chip select information, such that the modified encoded chip select information encodes a different value than the received encoded chip select information. The value modifier processes at least one information item of the received encoded chip select information to obtain an information item of the modified encoded chip select information. The electronic circuit further includes an output for outputting at least one output information item, the output information item representing the modified encoded chip select information. The electronic circuit further includes a circuit selection determinator for generating a circuit selection signal based on whether the received encoded chip select information or the modified encoded chip select information takes a predetermined reference value.

### TECHNICAL FIELD

Embodiments of the invention relate to an electronic circuit and to a method for selecting an electronic circuit.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1a shows a block schematic diagram of an electronic circuit, according to an embodiment of the invention;

FIG. 1b shows a block schematic diagram of an electronic circuit, according to an embodiment of the invention;

FIG. 2 shows a block schematic diagram of a chip module, according to an embodiment of the invention;

FIG. 3 shows a block schematic diagram of a chip, according to an embodiment of the invention;

FIG. 4 shows a schematic diagram of a value modifier, according to an embodiment of the invention;

FIG. 5a shows a logic table of a least significant bit mapping;

FIG. 5b shows a logic table of a mapping for a bit 2 to the power of n with n>0;

FIG. 6a shows a graphic representation of an exemplarily function for 16 planes;

FIG. 6b shows a graphic representation of auxiliary data used for the example of FIG. 6a;

FIG. 7a shows a first portion of a flow chart of a method, according to an embodiment of the invention; and

FIG. 7b shows a second part of a flow chart of a method, according to an embodiment of the invention.

### DETAILED DESCRIPTION OF ILLUSTRATIVE EMBODIMENTS

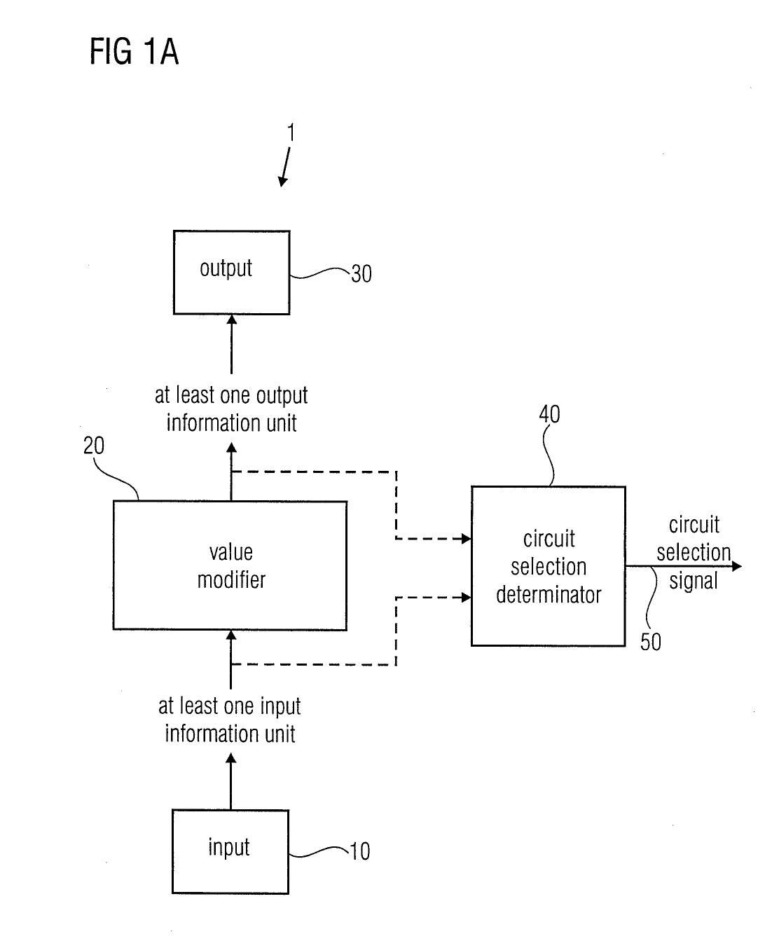

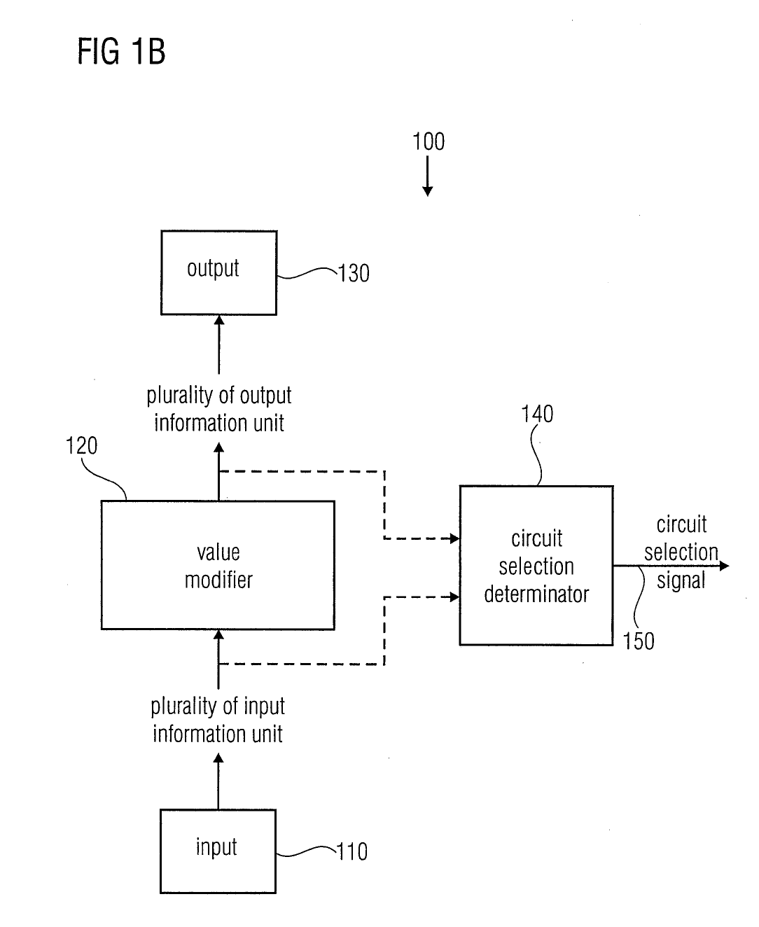

FIG. 1a shows a block schematic diagram of an electronic circuit, according to an embodiment of the invention. The electronic circuit of FIG. 1a is designated in its entirety with 1. The electronic circuit 1 comprises an input 10, a value modifier 20 and an output 30. The value modifier 20 is coupled to the input 10 to receive from the input 10 a plurality of input information items. Moreover, the value modifier 20 is coupled to the output 30 to output a plurality of output information items at the output 30.

The circuit 1 further comprises a circuit selection determinator 40 which is configured to receive either information input into the value modifier 20 or information output by the value modifier 20. The circuit selection determinator 40 is further configured to provide a circuit selection signal (or circuit select signal) 50.

In the following, the functionality of the circuit 1 will be described on the basis of the above structural description. The input 10 is configured to receive at least one input information item (or information unit), wherein the input information represents received encoded chip select information. The information item may, for example, comprise one or more bits, a nibble, a byte or a word. However, other information representations, for example one or more signals comprising more than two states, may be used to represent the information item. For example, the information item can be encoded in the form of one or more three-valued or multi-valued logic signals.

The value modifier 20 is configured to provide modified encoded chip select information in dependence on the received encoded chip select information. In an exemplary embodiment, the value modifier 20 may be configured to provide the modified encoded chip select information such that the modified encoded chip select information encodes a different value than the received encoded chip select information. The value modifier 20 is further configured to process at least one information item of the received encoded chip select information to obtain an information item of the modified encoded chip select information. In an embodiment, the value modifier 20 may, for example, be configured to logically process the at least one information item of the received encoded chip select information. However, other forms of processing are possible, for example analog processing. Moreover, the output 30 is configured to output at least one output information item, wherein the at least one output information item represents the modified encoded chip select information. The circuit selection determinator 40 is configured to generate the circuit selection signal 50 in dependence on whether the received encoded chip select information or the modified encoded chip select information takes a predetermined reference value.

According to one embodiment, the electronic circuit 1 is configured to provide modified encoded chip select information, modified with respect to received encoded chip select information. As a consequence, a further electronic circuit (not shown) may use the modified encoded chip select information, for example for addressing. Consequently, different electronic circuits (which may, for example, have identical circuit selection determinators) may, for example, be selected or enabled for different values of chip select information.

In the following, an embodiment of an electronic circuit will be described.

FIG. 1b shows a block schematic diagram of an electronic circuit, according to an embodiment of the present invention. The electronic circuit of FIG. 1b is designated in its entirety with 100. The electronic circuit 100 comprises an input 110, a value modifier 120 and an output 130. The value modifier 120 is coupled to the input 110 to receive from the input a plurality of input information items. Moreover, the value modifier 120 is coupled to the output 130 to output a plurality of output information items at the output 130.

The electronic circuit 100 further comprises a circuit selection determinator 140 which is configured to receive either information input into the value modifier 120 or information output by the value modifier 120. The circuit selection determinator 140 is further configured to provide a circuit selection signal (or circuit select signal) 150.

In the following, the functionality of the electronic circuit 100 will be described on the basis of the above structural description. The input 1 10 is configured to receive a plurality of input information items, wherein the input information represents received encoded chip select information. Moreover, the value modifier 120 is configured to provide modified encoded chip select information in dependence on the received encoded chip select information, such that the modified encoded chip select information encodes a different value than the received encoded chip select information. The value modifier 120 is further configured to combine at least two information items of the received encoded chip select information to obtain an information item of the modified encoded chip select information. Moreover, the output 130 is configured to output a plurality of output information items, wherein the output information items represent the modified encoded chip select information. The circuit selection determinator 140 is configured to generate a circuit selection signal in dependence on whether the received encoded chip select information or the modified encoded chip select information takes a predetermined reference value.

In other words, the value modifier 120 is adapted to receive encoded chip select information (e.g., address information) in the form of information items (e.g., single bits) which may be provided either by a parallel or a serial input (e.g., by the input 110). Moreover, the value modifier 120 is adapted to provide modified chip select information (e.g., modified address information) which is different from the incoming address information. Consequently, in an embodiment, different chip select information (e.g., representing different encoded values) is present at the output 130 when compared to the input 110. Moreover, the circuit selection determinator 140 may be configured to monitor whether either the received encoded chip select information or the outputted encoded chip select information encodes a certain predetermined reference value. Thus, the chip select determinator 140 may, for example, activate the circuit selection signal 150 if the encoded chip select information evaluated (or considered) by the circuit selection determinator 140 takes the predetermined reference value and may deactivate the circuit selection signal 150 otherwise.

The embodiment shown in FIG. 1b allows for the generation of a circuit selection signal 150 based on a plurality of input information items, while at the same time providing a plurality of output information items which can be used by another (possibly identical) circuit arrangement to generate another corresponding circuit selection signal (not shown). Thus, the circuit arrangement of FIG. 1b allows implementing a particularly efficient generation of a circuit selection signal 150, both in an environment where only one circuit arrangement 100 is used and in environments also where several circuit arrangements are used. Moreover, the circuit arrangement 100 can provide for the generation of a circuit selection signal 150 without using any additional signals other than the received encoded chip select information and the modified encoded chip select information. In contrast, the reference value may be predefined, i.e., does not need to be changed during the operation of the circuit arrangement 100. In some embodiments, the reference value may be hard wired.

Moreover, by obtaining the output information items on the basis of a combination of input information items, it is possible to adjust a flexible mapping of the received encoded chip select information to the modified encoded chip select information, such that in some embodiments an optimal use can be made of the set of values which can be encoded by the input information items or the output information items. In other words, in some embodiments it is possible to use most or even all of the values which can be encoded by the plurality of input information items. Consequently, an efficient use of the data transport capacity with respect to the transmission of input information items and/or output information items is made.

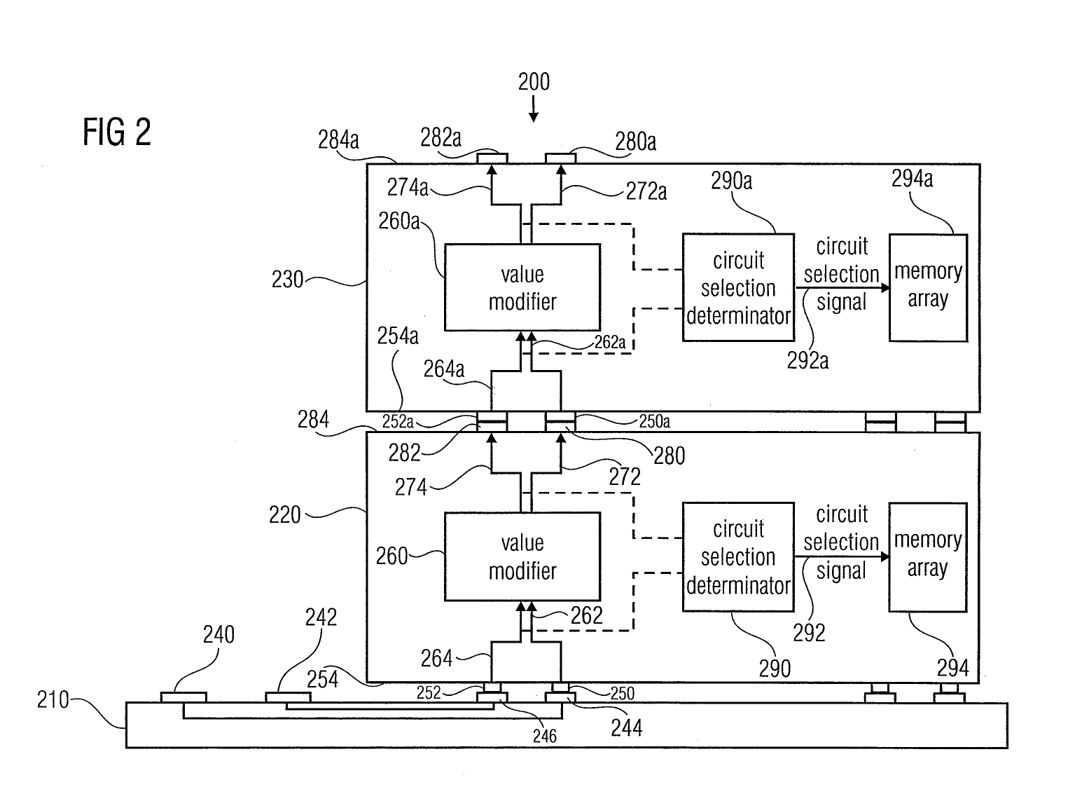

FIG. 2 shows a block schematic diagram of a memory module, according to an embodiment of the invention. The memory module of FIG. 2 is designated in its entirety with 200. The memory module 200 comprises a carrier substrate 210. A first chip 220 is mounted on the carrier substrate 210. Moreover, a chip module 230 is mounted or stacked onto the first chip 220 as will be described in more detail in the following.

The carrier substrate 210 comprises a first external contact 240 and a second external contact 242. According to a specification of the memory module 200, the first external contact 240 and the second external contact 242 may for example be address contacts. Moreover, the carrier substrate 210 may for example comprise a first chip contact (e.g., a contact pad) 244 and a second chip contact (e.g., a contact pad) 246. The first chip contact 244 may, for example, be electrically connected to the first external contact 240, and the second chip contact 246 may for example be coupled to the second external contact 242.

Moreover, the carrier substrate 210 may comprise additional contacts for other signals which will not be described here.

In the following, the first chip 220 will be described, but it should be noted that in some embodiments the second chip 230 may be identical to the first chip 220. The first chip 220 comprises, for example, a first address input contact 250 and a second address input contact 252. Both the first address input contact 250 and the second address input contact 252 are, for example, arranged on a first main surface (e.g., a bottom main surface) 254 of the first chip 220. The first address input contact 250 may, for example, be in electrical contact with the first chip contact 244 of the carrier substrate 210 and the second address input contact 252 of the first chip 220 may be in electrical contact with the second chip contact 246 of the carrier substrate 210. The first chip 220 further comprises a value modifier 260, the function of which may for example be identical to the function of the value modifier 120 of FIG. 1b.

The value modifier 260 may for example receive as the input information item address signals 262, 264 from the first address input contact 250 and the second address input contact 252. It should be noted that in some embodiments, the address information provided to the value modifier 260 may be considered to be received encoded chip select information.

The value modifier 260 is further adapted to provide the first address output signal 272 and the second address output signal 274. The address output signals 272, 274 may in some embodiments constitute modified encoded chip select information. In some embodiments, each of the address output signals 272, 274 may be considered as constituting or representing an output information item.

Moreover, the first chip 220 comprises a first address output contact 280 and a second address output contact 282, both of which may be arranged on a second main surface (or upper main surface) 284 of the first chip 220, wherein the second main surface 284 of the first chip 220 may be opposite to the first main surface 254 of the first chip 220.

However, in some other embodiments the input address information may be communicated to the first chip 220 via a serial (e.g., one wire) communication link, wherein only a single data line is present. Also, the value modifier 260 may provide the output address signal as a serial signal, which may, for example, be transmitted via only a single data line. In some alternative embodiments, there may also be more than two parallel (or serial) connections for the transmission of the address input signals and the address output signals of the value modifier 260.

The first chip 220 further comprises a circuit selection determinator 290, which may for example be adapted to recognize when the encoded chip select information received, for example, via the input address signals 262, 264, encodes a predetermined reference value. Alternatively (or additionally) the circuit selection determinator 290 may be adapted to recognize whether the modified encoded chip select information (represented, for example, by the output address signals 272, 274) takes a predetermined reference value. Moreover, the circuit selection determinator 290 may be adapted to provide a circuit selection signal 292 (which may be equivalent to the circuit section signal 150 of FIG. 1b) to a memory array 294, which may be part of the first chip 220. Thus, the memory array 294 may, for example, be activated for an access by the circuit selection signal 292, wherein the circuit selection signal 292 may, for example, be activated by the circuit selection determinator 290 upon the detection that the received encoded chip select information or the modified encoded chip select information takes the predetermined value. In contrast, if the encoded chip select information, which is evaluated by the circuit selection determinator 290 (e.g., the received encoded chip select information or the modified encoded chip select information) takes a value different from the predetermined reference value, the circuit selection determinator 290 preferably deactivates the circuit selection signal 292 such that the memory array 294 is deactivated (e.g., not available for an access).

However, memory array 294 may in some embodiments be replaced by any circuit which may be activated or deactivated. For example, the memory array 294 may be replaced by a processor adapted to process data and further adapted to exchange data with external data sources or data sinks. In this case, the processor may be adapted to exchange data only upon the activation of the circuit selection signal 292.

Moreover, the second chip 230 may comprise the same means as the first chip 220. For the sake of simplicity, means of the second chip 230 are designated with the same reference numerals as corresponding means of the first chip 220, wherein for the means of the second chip 230, an “a” has been added to the reference numerals.

The second chip 230 is, in some embodiments, stacked on the first chip 220, such that the first address input contact 250a of the second chip 230 is in electrical contact with the first address output contact 280 of the first chip 220. Moreover, the second address input contact 252a of the second chip 230 is in electrical contact with the second address output contact 282 of the first chip 220. Consequently, the second chip 230 receives as its received encoded chip select information an encoded chip select information provided (or outputted) by the first chip 220. As the modified encoded chip select information provided by the first chip 220 is different from (or encodes a different value than) the encoded chip selection information received by the first chip 220, an efficient chip select mechanism may be implemented. For example, the circuit selection determinator 290 of the first chip 220 may be configured to activate the circuit selection signal 292 only if the input address signals 262, 264 encode the value “00”. In contrast, if the input address signals 262, 264 encode the values “01” or “10” or “11”, the circuit selection determinator 290 may, for example, deactivate the circuit selection signal 292. Moreover, the value modifier 260 may be adapted to map combinations of the input address signals to combinations of the output address signals in the following way.

| | | |
|---|---|---|
| “00” | → | “01”; |
| “01” | → | “10”; |
| “10” | → | “11”; |
| “11” | → | “00”. |

Moreover, the value modifier 260a and the second chip 230 may, for example, be adapted to form the same mapping of the input address signals 262a, 264a to the output address signals 272a, 274a. The circuit selection determinator 290a of the second chip 230 may also be configured in the same way as the circuit selection determinator 290 of the first chip 220. Thus, the predetermined reference value for the second chip 230 may be identical to the predetermined reference value for the first chip 220. In other words, the circuit selection determinator 290a may be configured to activate the circuit selection signal 292a if the input address signals 262a, 264a of the second chip 230 encode the signal combination “00”.

Thus, if the signal combination “00” is present at the address input contacts 250, 252 of the first chip 220, the circuit selection determinator 290 of the first chip 220 may activate the circuit selection signal 292. Consequently, the memory array 294 of the first chip 220 (or any other circuit replacing the memory array 294) may be activated for access. Moreover, under the conditions, the first chip 220 may output the signal combination “01” to the second chip 230 via the address output contacts 280, 282. In response to the signal combination “01”, the circuit selection determinator 290a of the second chip 230 may deactivate the selection signal 292a. Moreover, the second chip may provide at its address output contacts 280a, 282a signal combination “10”.

If, however, the signal combination “11” is present at the address input contacts 250, 252 of the first chip 220, the circuit selection determinator 290 of the first chip 220 may for example deactivate the circuit selection 292. The first chip 220 may in this case output at its output address contacts 280, 282 the signal combination “00”, according to the above-described mapping rule of the value modifier 260. In response to the presence of the signal combination “00” at the address input contacts 250a, 252a, the circuit selection determinator 290a of the second chip 230 may activate the circuit selection signal 292a. Moreover, according to the mapping rule of the value modifier 260a, the second chip 230 may output the signal combination “01” at the address output contacts 280a, 282a.

To summarize the above, the first chip 220 may, for example, be activated in response to the presence of the signal combination “00” at the address input contacts 250, 252 and the second chip 230 may be activated in response to the presence of the signal combination “11” at the same address input contacts 250, 252. For the presence of the signal combinations “01” and “10” neither of the chips 220, 230 is activated. However, if (possibly identical) chips (e.g., further chips) are stacked on the second chip 230, those chips might for example be activated in response to the presence of the signal combinations “10” and “01” at the address input contacts 250, 252 at the first (or lower most) chip 220.

While the functionality of addressing several chips stacked on the chip module has been described for an encoding scheme where two signals (namely a first address signal and a second address signal) are used, the concept could of course be extended to systems in which more than two signals are used for chip selection (i.e., as input signals for the value modifier 260). In this case, the mapping rule of the value modifier 260 may of course be more complex. For example, signal combinations of more than two input signals (or input address signals) may be mapped to signal combinations of more than two output signals or output address signals. The circuit selection determinator 290 may also take into consideration combinations of more than two signals (representing, for example, the received encoded chip select information or the modified encoded chip select information).

In an alternative embodiment, the circuit selection determinator 290 of the first chip 220 may be configured to activate the circuit selection signal of the first chip 220 if a signal combination “11” is present at the input terminals of the first chip 220. Similarly, the circuit selection determinator 290a of the second chip 230 may be configured to activate the circuit selection signal of the second chip 230, if the signal combination “11” is present at the input terminals of the second chip 230.

Consequently, the first chip 220 is activated (i.e., its circuit selection signal is activated) if the signal combination “11” is present at the address input contacts 250, 252 of the first chip 220. Likewise, the second chip 230 is activated if the signal combination “10” is present at the address input contacts 250, 252 of the first chip 220.

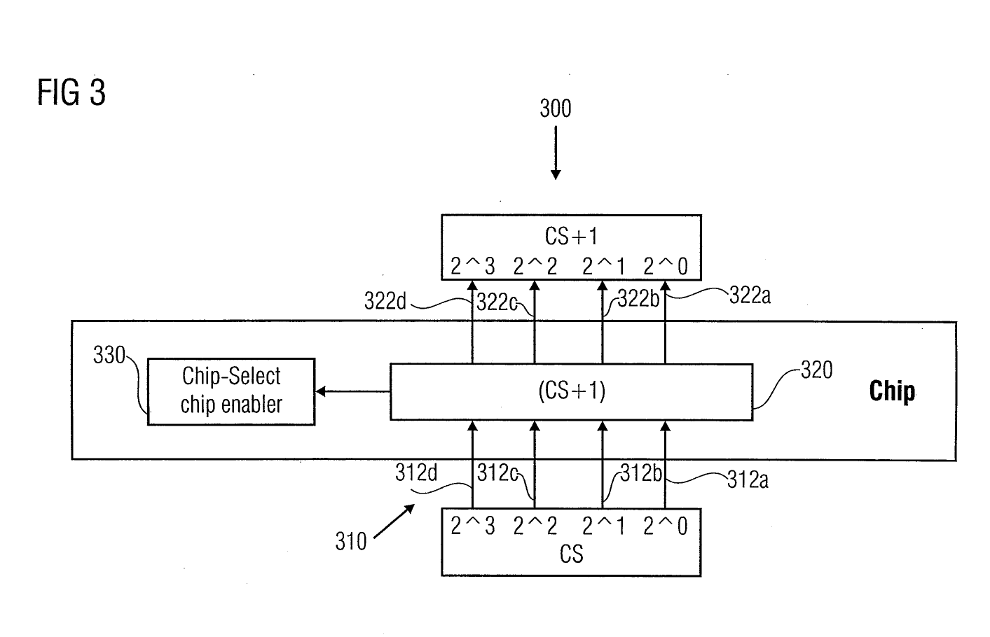

FIG. 3 shows a block schematic diagram of a chip, according to an embodiment of the invention. The chip of FIG. 3 is designated in its entirety with 300. The chip 300 comprises an input 310 for a plurality of chip select information signals 312a-312d. The chip select information signals 312a-312d, may, for example, be configured to provide binary encoded chip select information (or binary encoded address information). For example, the signal 312a may provide a least significant bit (2⁰ or 2̂\hat{0}). The signal 312b may, for example, encode the binary value of 2 (2¹ or 2̂\hat{1}). The third signal 312c may encode a binary code value of 4 (2² or 2̂\hat{2}), and the fourth signal 312d may, for example, encode binary value 8 (2³ or 2̂\hat{3}).

The chip 300 further comprises a binary adder 320, which may, for example, be configured to add “1” to a value encoded by the chip select information signals 312a-312d.

The adder 320 may thus be configured to provide modified chip select information signals 322a-322d encoding (e.g., in a binary form) modified encoded chip select information. The signals 322a-322d may describe different binary values, for example 1 (2⁰), 2 (2¹), 4(2²) and 8 (2³).

The chip 300 may further comprise a chip-select chip enabler 330 which may, for example, take the function of the circuit selection determinators 140, 290, 290a. In other words, the chip-select chip enabler 330 may be configured to provide chip select information or a chip select signal in dependence on the value encoded by the received encoded chip select information (represented by signals 312a-312d) or the modified encoded chip select information (represented by the signals 322a-322d). Thus, the chip-select chip enabler 330 may be configured to determine whether the received encoded chip select information or the modified encoded chip select information takes a predetermined value, wherein the predetermined value may be configured to be constant during the operation of the chip. For example, the predetermined value may be hard wired or the predetermined value may be configured to be changed only in a configuration mode of the chip 300.

Moreover, outputs for the signals 322a-322d (representing the modified encoded chip select information) may be on an opposite main surface of the chip 300 when compared to inputs for the signals 312a-312d (representing received encoded chip select information). Thus, the chip 300 may be configured for stacking.

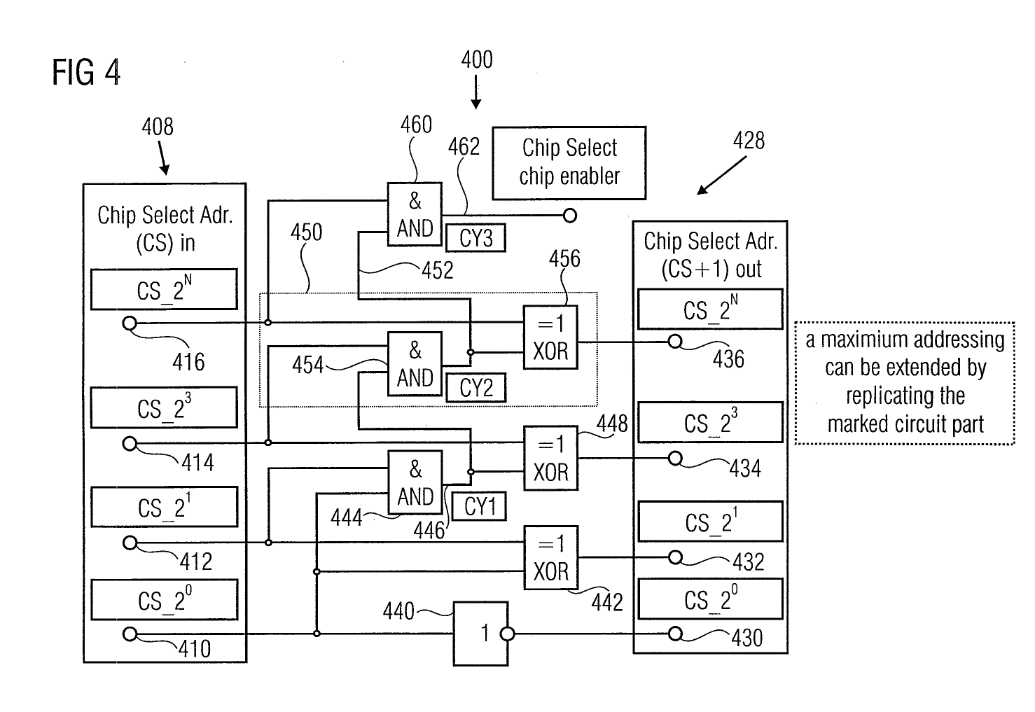

FIG. 4 shows a schematic diagram of an exemplarily circuit implementing both a value modifier and a circuit selection determinator. The circuit of FIG. 4 is designated in its entirety with 400. The circuit 400 comprises, for example an input 408 comprising four individual inputs 410, 412, 414, 416 for inputting a chip select address. The chip select address input via the inputs 410-416 may, for example, represent received encoded chip select information. In an embodiment, the received encoded chip select information may be encoded in a binary form. Thus, the first input for a chip select address may be configured to receive a least significant bit (CS_2⁰) of the chip select address. The input 416 may be configured to receive a most significant bit (CS_2^{N}) of the chip select address. Moreover, inputs 412 and 414 may be adapted to receive the other bits of the encoded chip select address (for example bits CS_2¹ and CS_2³).

Moreover, the circuit 400 comprises an output 428 for an encoded modified chip select address (also designated as “chip select address (CS+1) out”). The output 428, for example, comprises four individual outputs for providing four signals representing the modified chip select address in a binary encoded form. The output signals are designated with 430-436 (and may alternatively be designated with CS_2⁰, CS_2¹, CS_2³ and CS_2^{N}).

The circuit 400 comprises an inverter 440, which receives (is configured to receive) the first input signal 410 and outputs (is configured to output) the first output signal 430. In other words, a least significant bit signal 430 of the output 428 is derived from a least significant bit signal 410 at the input 408.

The circuit 400 further comprises a XOR gate 442, which is configured to receive the first input signal 410 and the second input signal 412, and to provide the second output signal 432. The circuit 400 further comprises an AND gate 444, which is configured to receive the first input signal 410 and the second input signal 412 and to provide a first carry signal 446, also designated with CY1. The circuit 400 comprises a second XOR gate 448, which is configured to receive the first carry signal 446 and the third input signal 414. Moreover, the second XOR gate 448 is configured to provide the third output signal 434.

Moreover, the circuit 400 comprises a logic stage 450 configured to receive an (n−1)-th input signal (e.g., the third input signal 414), a previous carry signal (for example the first carry signal 446) and a n-th input signal (e.g., the fourth input signal 416) and to provide a n-th output signal (for example the fourth output signal 436) and a carry signal (for example, a second carry signal 452, also designated with CY2). The logic stage 450 comprises, for example, a corresponding AND gate 454 (e.g., a second AND gate), configured to receive the (n−1)-th input signal (e.g., the third input signal 414) and the previous carry signal (e.g., the first carry signal 446). The second AND gate 254 of the logic stage 450 is further configured to provide the carry signal 452 of the logic stage 450. The logic stage 450 comprises an XOR gate (e.g., a third XOR gate 456). The third XOR gate 456 of the logic state 450 is configured to receive the n-th input signal (e.g., the fourth input signal 416) and the second carry signal 452 of the logic stage 450, and to provide the n-th output signal 436.

The circuit 400 further comprises a third AND gate 460 configured to receive the fourth input signal 416 and the second carry signal 452. Moreover, the third AND gate 460 is configured to provide a third carry signal 462, which may be used as a chip select chip enabler or as a chip select signal.

In other words, the circuit 400 is configured to provide both a modified chip select address, encoded by a plurality of output signals 430-436, and a chip select signal 462 on the basis of a received chip select address encoded, for example, by a plurality of signals 410-416. The circuit arrangement of FIG. 4 is particularly simple and provides for a sufficiently fast propagation delay value.

However, it should be noted that the circuit of FIG. 4 can be modified in a number of ways. For example, in a very simple embodiment, the third input 414, the fourth input 416, the third output 434 and the fourth output 436 may be omitted. In this case, the logic block 450 and the third AND gate 460 may also be omitted and the first carry signal 446 may, for example, serve as the chip select signal.

However, in other embodiments, a maximum addressing range may be extended by replicating the logic block 450, i.e. the circuit part marked by a dotted line. In such an embodiment, more than four input signals may be used and more than four output signals may be provided. An additional logic block may, for example, be configured to receive the fourth input signal 416 (as a (n−1)-th input signal) and a fifth input signal (not shown) (as a n-th input signal) as well as the second carry signal 452 (as a previous carry signal). Moreover, the additional logic block may provide a fifth output signal (not shown) (as a n-th output signal). It should be noted that the additional logic block may be identical to the logic block 450. Besides, further logic blocks may be cascaded. Thus, an addressing on the basis of five or more chip select address signals may be provided.

In another embodiment, three chip select address signals may be used. In this case, the fourth input signal 416 and the fourth output signal 436 can be omitted as well as the third XOR gate 456 and the third AND gate 460. The second carry signal 452 may serve as a chip select signal in this case.

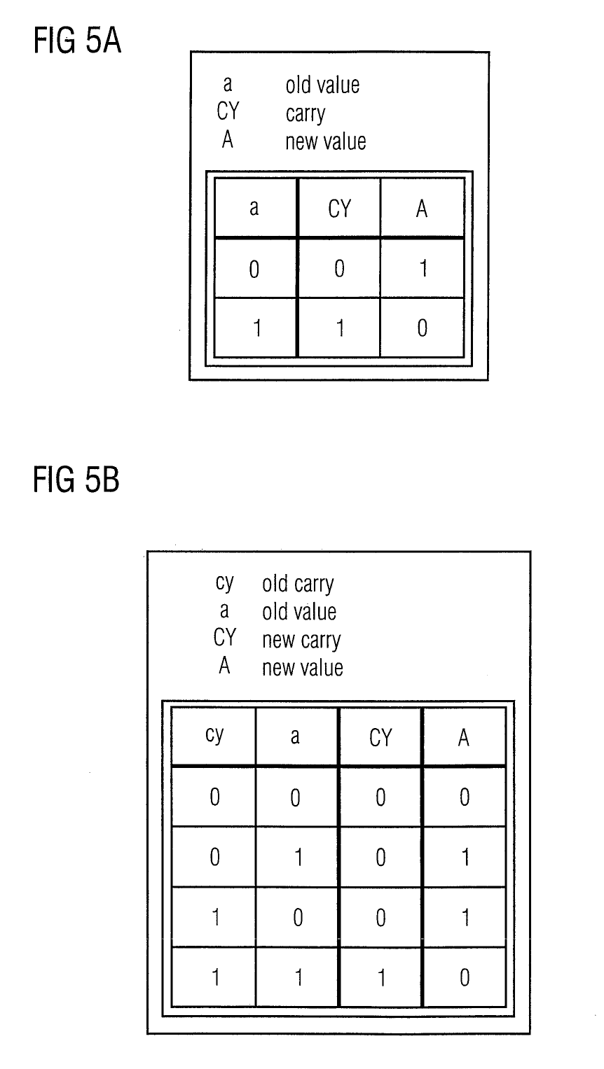

For the sake of explanation, logic tables FIG. 5a and FIG. 5b are given for different parts of the circuit 400. FIG. 5a shows a first logic table describing a relationship between a least significant input bit, a least significant output bit and a carry signal of a least significant stage. It should be noted that in the logic table of FIG. 5a, the variable “a” designates an “old value”, i.e., a value of the least significant bit of the input signal. For example, the variable “a” may designate the first input signal 410. A variable “CY” designates carry information, and a variable “A” designates a “new value” i.e., an output signal for the least significant bit. As can be seen from the logic table of FIG. 5a, the carry signal for the least significant bit is identical to the input signal for the least significant bit. The output signal “A” for the least significant bit is the inverse of the input signal afore the least significant bit.

FIG. 5b shows a logic diagram (or truth table) regarding the calculation of an output signal and a respective carry signal for bits other than the least significant bit. A variable “cy” designates an “old carry”, i.e., a carry signal received from a previous stage, a variable “a” designates an old value, i.e., an input signal of the stage (e.g., an input signal of the n-th stage), a variable “CY” designates a “new carry”, i.e., a carry signal provided by the n-th stage, and a variable “A” designates a “new value” i.e., an output signal of the n-th stage. For example, the variable “a” may designate the third input signal 414, the variable “cy” may designate the first carry signal 446, the variable “A” may designate the third output signal 434 and the variable “CY” may designate the second carry signal 452.

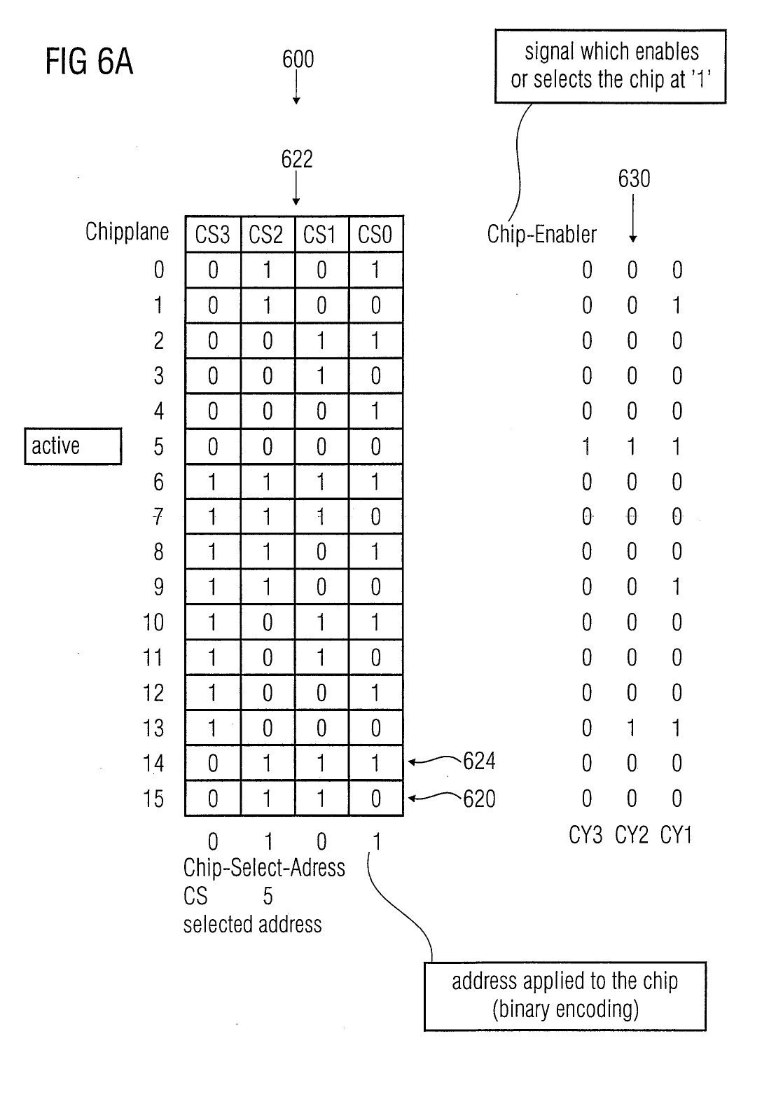

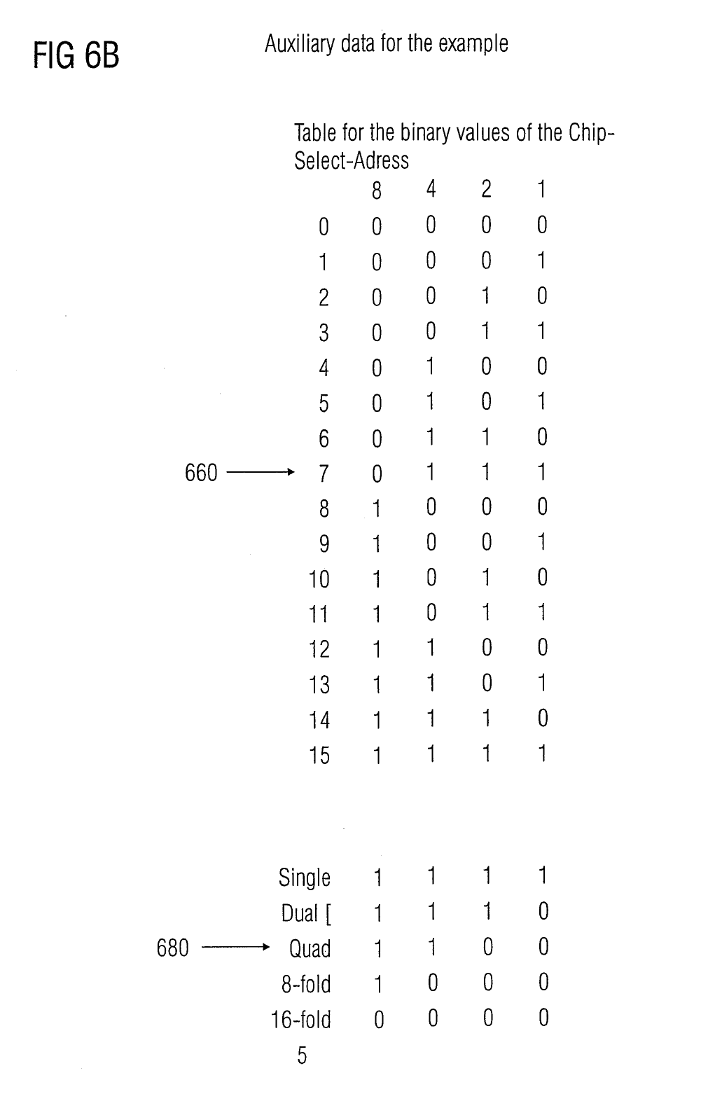

FIG. 6a shows a graphical representation of signals, which may be present in different planes of a chip stack. The graphical representation of FIG. 6a is designated in its entirety with 600. Regarding the graphical representation of FIG. 6, it is assumed that 16 identical chips, for example chips 220, 230 or 300 are stacked. Taking reference to the graphical representation of FIG. 2, the first chip 220 may be considered as a “plane-15-chip” and the second chip 230 may be considered as a “plane-14-chip”. Moreover, further chips, which may be stacked on top of the second chip 230, might be regarded as “plane-13-chip” down to “plane-0-chip”.

Taking reference to the memory module 200 of FIG. 2, only two address input contacts 250, 252 are shown. However, in order to make the explanations of FIG. 6a applicable to the memory module 200 of FIG. 2, it should be assumed that each of the chips 220, 230 of the memory module 200 comprises four address contacts, or any other possibility (e.g., a serial interface) to receive and transmit four input information items and four output information items, respectively. Assuming that each of the chips 220, 230 comprises four input address contacts and four output address contacts, it could be assumed that four encoded chip select signals, namely chip select signals CS0, CS1, CS2, CS3 are associated to the inputs. In the example of FIG. 6a, it is assumed that the signal combination “0101” is supplied to the first chip 220, which is considered to be the “plane-15-chip”.

Consequently, the first chip 220 (plane-15-chip) outputs the signal combination “0110” at its output address contact, which contact is shown in a lowermost row 620 of table 622. Output signals of the second chip 230 provided to a further chip via the address output contacts are shown in row 624 of the table 622. Further rows of the table 622 show output signals output at the address contacts of further stacked chips.

Moreover, a carry signal representation 630 shows values of carry signals, wherein it is assumed that the value modifier 260 and the chip selection determinator 290 are realized (in combination) by the circuit 400. While the inverter 440, the first AND gate 444 and the second AND gate 454, as well as the XOR gates 442, 448, 456 form the value modifier, the third AND gate 460 can be considered to make up the circuit selection determinator 140. However, it could alternatively be stated that the circuit selection determinator 290 also comprises the first AND gate 444 and the second AND gate 454, wherein it could be stated that the first AND gate 444 and the second AND gate 454 comprise a double function serving both for the provision of a modified chip select address and the provision of the circuit selection signal.

Referring now to the graphical representation 600 of FIG. 6a, it can be seen that the third carry signal 462 is only active in a chip of chip plane 5, which chip receives at its input address contact the signal combination “1111” and which chip provides at its output address contacts the signal combination “0000”. Consequently, only the chips of chip plane 5 are active, while the chips of chip planes 0-4 and chip planes 6-15 are inactive. In other words, if the third carry signal 462 is considered to be the chip enabler signal, i.e., the signal which enables or selects a chip at a value of “1”, the chip of chip plane 5 is activated when the chip select address of “5” (“0101”) is applied to the address input contacts of the lowermost chip.

FIG. 6b shows a graphical representation of auxiliary data for the example described with reference to FIG. 6a. FIG. 6b shows a table 660 for the binary values of the chip select address. In other words, table 660 describes the binary coding of different decimal values (0-15).

Moreover, it should be noted that a chip comprising, for example, a circuit 400 of FIG. 4 can be used individually, as dual dies, quad dies or in similar configurations by permanently applying a “1” (or logic 1) signal to the chip select (CS_X)-lines. By applying logic value “1” to all chip select lines, a chip can be used as a single die. In other words, if a stack of chips, for example, comprises 2^{N} chips, then N chip select lines (or address lines) are used, and additional address lines, which may be present, may be set to a logic value of “1”. A table 680 shows logic values applied to the different address lines in dependence of the mode of operation of a chip or in dependence on how many chips are put together to form a stack. If a chip is used as a single chip, a signal combination “1111” may be applied to the address lines. If two chips are attached to each other to form a dual chip stack, the three higher most address lines are set to a signal combination “111” and the least significant bit is configured to receive an address signal. If four chips are combined to form a quad chip stack, a signal combination of “11” may be applied to the higher most bits, and the two lower most bits may be configured to receive two address bits.

If eight chips are stacked to form an 8-fold stack, a signal value of “1” may be applied to the most significant bit, and the three lower most bits may be configured to receive three address signals. If 16 chips are stacked to form a 16-fold stack, all four address signal inputs may be configured to receive address signals.

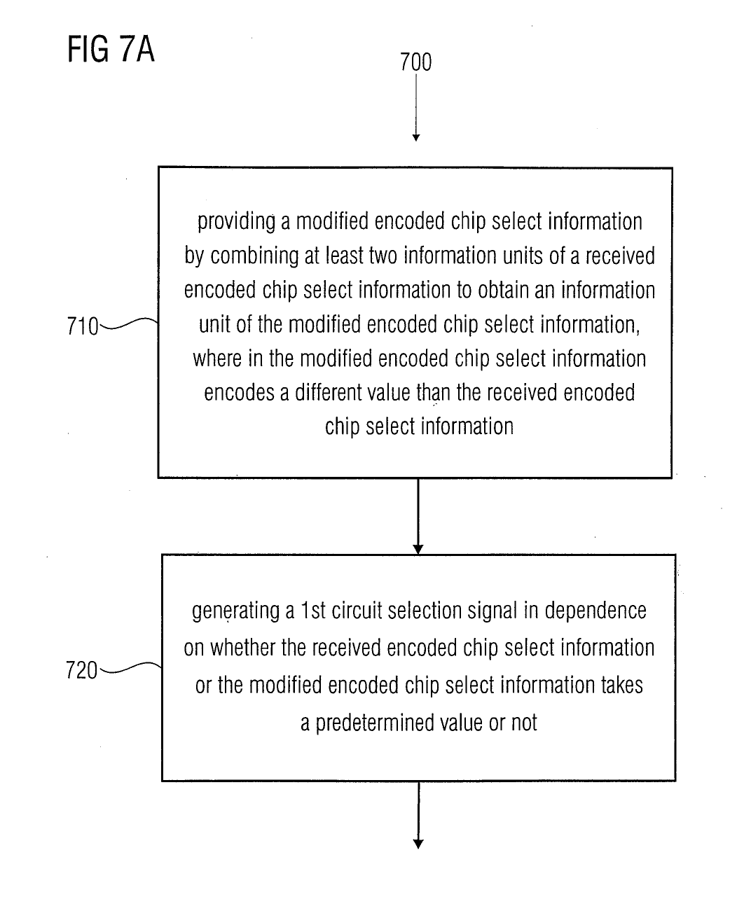

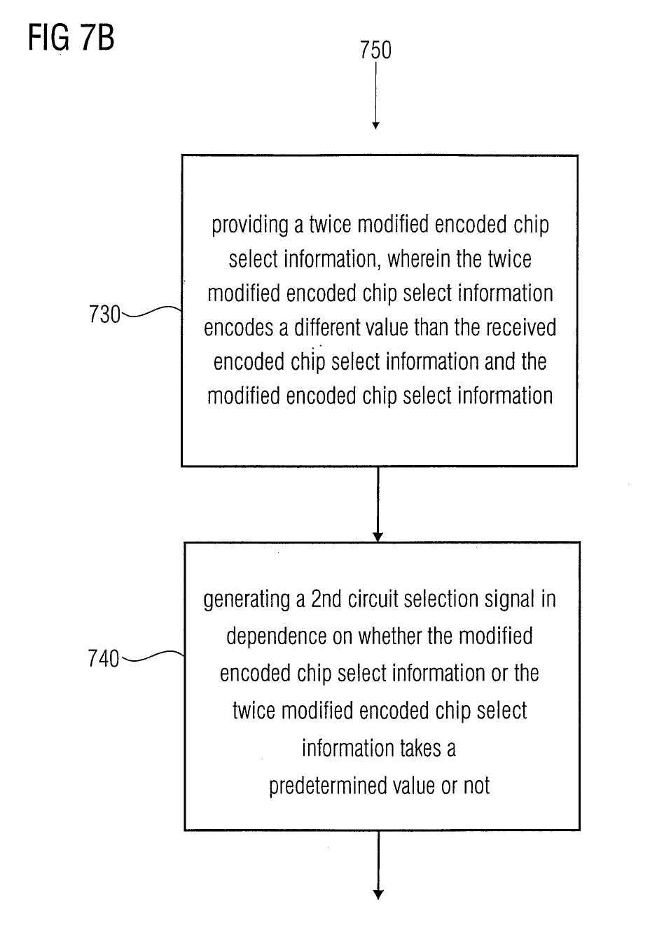

FIG. 7a shows a block schematic diagram of a method, according to an embodiment of the invention. The method of FIG. 7a is designated in its entirety with 700. The method 700 comprises a first step 710 of providing modified encoded chip select information by combining at least two information items of received encoded chip select information to obtain an information item of the modified encoded chip select information. The modified encoded chip select information encodes a different value than the received encoded chip select information. The method 700 comprises a second step 720 of generating a first circuit selection signal in dependence on either the received encoded chip select information or the modified encoded chip select information. However, the method 700 may optionally be supplemented by any of the steps and features of the circuits and means described within the present invention.

Moreover, FIG. 7b shows a flow chart of additional steps, by which the method 700 can be supplemented. The steps of FIG. 7b are designated in their entirety with 750. The steps 750 comprise a third step 730 of providing twice-modified encoded chip select information, wherein the twice-modified encoded chip select information encodes a different value than the received encoded chip select information. According to some embodiments, the twice-modified chip selection information may be generated on the basis of the modified chip select information.

Step 750 further comprises a fourth step 740 of generating a second circuit selection signal in dependence on whether the modified encoded chip select information or the twice-modified encoded chip select information takes a predetermined value.

In the following, some aspects of embodiments of the present invention will be briefly summarized. Some embodiments of the invention implement an address encoding in a chip (i.e., an on-chip address encoding). Embodiments of the present invention may be used to replace solutions, wherein an individual chip select line is used for addressing individual planes in the multichip components. Thus, some embodiments of the present invention may help to reduce additional efforts for a chip selection when stacking more than four planes. Some embodiments of the present invention allow for the inclusion of a chip in single die components and in any arbitrary plane of multi-die components. Moreover, in some embodiments of the present invention, an encoding of the plane is used which is different from a one-out-of-X encoding. In other words, in some embodiments of the invention, applying an encoding wherein x lines are used when addressing x chips, and wherein one of the x lines is activated to select the chip, is avoided.

Some embodiments of the present invention may use a 2ⁿ plane encoding. Consequently, if the number of planes is doubled, only one further address line is required in some embodiments.

According to some embodiments of the present invention, an encoding of the address of a chip using logic gates on silicon is used. Consequently, chips according to some embodiments are usable in any plane and further use an efficient binary code.

According to some embodiments, an address, which is handed over to a chip, is passed on to the next plane in a modified form by the chip. Some embodiments of the present invention use a circuit which increments the address value by 1. Moreover, some embodiments use a carry signal or an overflow signal, which may occur when incrementing, as the chip select signal.

According to some embodiments, it can be fixed during the chip design up to how many levels or planes the chip can be stacked. However, according to some embodiments, it is possible to include a chip for 16 planes in single die components or dual die components, by means of providing an appropriate external circuitry or by means of applying appropriate levels to the input.

According to some embodiments, a logic circuit for implementing more significant bits is an XOR combination of the old value (for example a received address bit) and the carry of the previous less significant digit (the digit being less significant by 1). The carry can be obtained on the basis of the old value (for example a received address bit), for example, AND-combined with the old carry or the old overflow.

FIG. 5a shows a truth table for a least significant bit (LSB) and FIG. 5b shows a truth table for a more significant bit (bit 2ⁿ; n>0).

According to some embodiments, a carry of the most significant bit (MSB) is the chip select signal for a plane.

According to some embodiments of the invention, an address encoding is done in a chip. According to some further embodiments of the invention, a different encoding other than a 1-out-of-X encoding is used for a chip select.

Some embodiments of the invention can be applied in multi-die-components of different memory technologies. Some embodiments of the present invention may also be used to address several equivalent (or even identical) circuits by a chip select. Moreover, it should be noted that the term least significant bit (LSB) means a bit having the lowest weight. The term most significant bit (MSB) designates a bit having the highest weight.

Depending on certain implementation requirements of the inventive method, the inventive method can be implemented in hardware or in software. The implementation can be performed using a digital storage medium, for example a floppy disk, a DVD, a CD, a ROM, a PROM, an EPROM, an EEPROM, non-volatile RAM or a FLASH memory having electronically readable control signals stored thereon, which cooperate with a programmable computer system such that the inventive method is performed. Generally, the present invention is, therefore, a computer program product with a program code stored on a machine readable carrier, the program code being operative for performing the inventive method when the computer program product runs on a computer. In other words, the inventive method is, therefore, a computer program having a program code for performing the inventive method when the computer program runs on a computer.

In addition, the concept of encoding planes using a circuit selection determinator could also be implemented statically. If a signal combination of “0” or “00” (or any other static signal combination) is applied to the lowermost chip (e.g., to the first chip 220), the chips (e.g., chips 220, 230) obtain plane values in a predetermined order. In such an embodiment, the circuit selection determinator may be configured to compare an applied address with the resulting plane value and to activate or enable the respective chip in dependence on the result of the comparison.

Moreover, the above described concept may also be used for stacking circuits other than memories, for example processors or microcontrollers. In other words, it is not of significance which functionality the stacked chips actually comprise. Besides, different types of devices may be combined in a single stack of devices. For example, a stack may optionally comprise two or more devices out of the following list: memory devices, processor devices, peripheral devices, and microprocessor devices.

Besides it should be noted that inputs and outputs of the chips can be realized in different ways. Although inputs and outputs have been described, bi-directional input/output connections may be used.

Also, different representations of the signals may be used. For example, the inputs or outputs may be configured to forward electrical or optical signals, or any other signals usable for the exchange of information. In an embodiment, capacitive coupling may be used to exchange signals between chips, or between a chip and a substrate. Alternatively, an electrically conductive coupling may be used.

In addition, any of the logic processing or logic combining described above may, for example, be performed using electrical logic gates. Alternatively, any other processing means or signal combining means may be used. For example, optical gates may be used in an embodiment.

Moreover, the above described concept may also be applied on a single chip. If, for example, several memory arrays are arranged on a chip in parallel, these memory arrays get a unique addressing by means of the above described concept or method.

Moreover, with respect to the above described concept, it is not relevant how the chips are arranged on contacts. For example, the stacked chips may be addressed via a substrate or via a plurality of substrates. Alternatively, the chips may be connected to a printed circuit board (PCB) via bond wires. Moreover, the chips may be arranged directly on the printed circuit board, like, for example, wafer level packages. A stack of chips (or even a plurality of stacks) may, for example, be mounted on another die.

What is claimed is:

1. An electronic circuit, comprising:
an input configured to receive at least one input information item, the at least one input information item representing received encoded chip select information;
a value modifier configured to provide modified encoded chip select information based on the received encoded chip select information, wherein the value modifier is configured to process at least one information item of the received encoded chip select information to obtain an information item of the modified encoded chip select information;
an output configured to output at least one output information item, the output information item representing the modified encoded chip select information; and
a circuit selection determinator configured to generate a circuit selection signal on the basis of the received encoded chip select information or the modified encoded chip select information.

2. The electronic circuit of claim 1, wherein the circuit selection determinator is configured to generate the circuit selection signal depending on whether the received encoded chip select information or the modified encoded chip select information takes a predetermined reference value.

3. The electronic circuit of claim 1, wherein the value modifier is configured to provide the modified encoded chip select information such that the modified encoded chip select information encodes a different value than the received encoded chip select information.

4. The electronic circuit of claim 1, wherein the value modifier is configured to logically process at least one information item of the received encoded chip select information to obtain an information item of the modified encoded chip select information.

5. The electronic circuit of claim 1, wherein the value modifier comprises an inverter configured to invert at least one input information item to obtain a corresponding information item of the modified encoded chip select information.

6. The electronic circuit of claim 1,
wherein the input is configured to receive a plurality of input information items, the plurality of input information items representing the received encoded chip select information;
wherein the value modifier is configured to combine at least two information items of the received encoded chip select information to obtain an information item of the modified encoded chip select information; and
wherein the output is configured to output a plurality of output information items, the output information items representing the modified encoded chip select information.

7. The electronic circuit of claim 2, wherein the predetermined reference value is fixed in an operation mode in which the electronic circuit fulfills a main functionality.

8. The electronic circuit of claim 2, wherein the predetermined reference value can be amended only in a configuration mode of the electronic circuit.

9. The electronic circuit of claim 2, wherein the predetermined reference value is determined by a hard wired circuit configuration, such that the predetermined reference value is fixed during an operation of the electronic circuit.

10. The electronic circuit of claim 2, further comprising a memory array, wherein the predetermined reference value is independent from any memory-access-address information.

11. The electronic circuit of claim 1, wherein the input is configured to receive a plurality of parallel input signals, wherein the parallel input signals constitute the input information items, and
wherein the output is configured to output a plurality of parallel output signals, wherein the parallel output signals constitute the output information items.

12. The electronic circuit of claim 1, wherein the input is configured to receive a serial input signal, wherein subsequent symbols of the serial input signal constitute the input information items, and wherein the output is configured to output a serial output signal, wherein subsequent symbols of the serial output signal constitute the output information items.

13. The electronic circuit of claim 1, wherein possible encoded values of the encoded chip select information comprises an ordered ring sequence, such that each possible encoded value comprises a successor value, and wherein the value modifier is adapted to provide the modified encoded chip select information such that the modified encoded chip select information encodes the successor value of the encoded value represented by the received encoded chip select information.

14. The electronic circuit according to claim 1, wherein the received encoded chip select information is a binary encoded input value,
wherein the value modifier comprises an adder configured to add a predetermined value to the binary encoded input value to obtain a binary encoded output value, or a subtractor configured to subtract a predetermined value from the binary encoded input value to obtain the binary encoded output value, and
wherein the binary encoded output value forms the modified encoded chip select information.

15. The electronic circuit of claim 14, wherein the circuit selection determinator is configured to generate the circuit selection signal in dependence on at least one carry signal provided by the value modifier when adding the predetermined value to the binary encoded input value or when subtracting the predetermined value from the binary encoded input value.

16. The electronic circuit of claim 14, wherein the value modifier is configured to increase or decrease the binary encoded input value by 1 to obtain the binary encoded output value.

17. The electronic circuit of claim 14, wherein the value modifier is configured to increase or decrease the binary encoded input value using a modulo increase operation or a modulo decrease operation.

18. The electronic circuit of claim 1, wherein the electronic circuit is arranged on a chip,
wherein the chip comprises a first main surface and a second main surface opposite to the first main surface,
wherein the input is arranged on the first main surface, and
wherein the output is arranged on the second main surface.

19. The electronic circuit of claim 18, wherein the input and the output are arranged on the chip such that two identical chips can be stacked such that the input of a second chip is in electrical contact with the output of a first chip.

20. The electronic circuit of claim 1, wherein the input comprises a chip-to-chip connection contact, and wherein the output comprises a chip-to-chip connection contact.

21. The electronic circuit of claim 1, wherein the input comprises a pull-down element or a pull-up element to bring the input to a predetermined state if the input is left open.

22. The electronic circuit of claim 6, wherein the input is configured to receive at least two input signals, and wherein the output is configured to output at least two output signals;
wherein the value modifier comprises a first inverter configured to provide a first output signal as an inverse of a first input signal;
wherein the value modifier comprises a first XOR-gate configured to provide a second output signal by XOR-combining the first input signal and a second input signal;
wherein the value modifier comprises an AND-gate configured to provide an overflow signal by AND-combining the first input signal and the second input signal; and
wherein the circuit selection determinator is configured to derive the circuit selection signal from an overflow signal.

23. A circuit arrangement, comprising:
a first electronic circuit; and
a second electronic circuit;
each of the first electronic circuit and the second electronic circuit comprising:
an input configured to receive at least one input information item, the at least one input information item representing received encoded chip select information,
a value modifier configured to provide a modified encoded chip select information based on the received encoded chip select information, wherein the value modifier is configured to process at least one information item of the received encoded chip select information to obtain an information item of the modified encoded chip select information,
an output configured to output at least one output information item, the output information item representing the modified encoded chip select information, and
a circuit selection determinator configured to generate a circuit selection signal in dependence on whether the received encoded chip select information or the modified encoded chip select information takes a predetermined reference value,
wherein the input of the second electronic circuit is electrically coupled to the output of the first electronic circuit.

24. The circuit arrangement of claim 23,
wherein the input of the first electronic circuit is configured to receive a plurality of input information items, the input information items representing received encoded chip select information;
wherein the value modifier of the first electronic circuit is configured to combine at least two information items of the received encoded chip select information to obtain an information item of the modified encoded chip select information;
wherein the output of the first electronic circuit is configured to output a plurality of output information items, the output information items representing the modified encoded chip select information;
wherein the input of the second electronic circuit is configured to receive a plurality of input information items, the input information items representing a received encoded chip select information;
wherein the value modifier of the second electronic circuit is configured to combine at least two information items of the received encoded chip select information to obtain an information item of the modified encoded chip select information; and
wherein the output of the second electronic circuit is configured to output a plurality of output information items, the output information items representing the modified encoded chip select information.

25. The circuit arrangement of claim 23, further comprising a first chip and a second chip, wherein the first chip comprises the first electronic circuit, and wherein the second chip comprises the second electronic circuit.

26. The circuit arrangement of claim 25, wherein the second chip is stacked on top of the first chip to form a chip stack, and
wherein the input of the second electronic circuit is electrically coupled to the output of the first electronic circuit via a chip-to-chip connection.

27. The circuit arrangement of claim 25, wherein the first chip is identical to the second chip.

28. The circuit arrangement of claim 23, wherein the first electronic circuit comprises a memory array, and wherein the second electronic circuit comprises a memory array;
wherein the memory array of the first electronic circuit is configured to be activated for an access in response to the activation of a corresponding circuit selection signal;
wherein the memory array of the second electronic circuit is configured to be activated for an access in response to the activation of a corresponding circuit selection signal;
wherein the memory array of the first electronic circuit is activated in response to a reception of first encoded chip select information at the input of the first electronic circuit;
wherein the memory array of the second electronic circuit is activated in response to a reception of second encoded chip select information at the input of the first electronic circuit; and
wherein the second encoded chip select information is different from the first encoded chip select information.

29. A memory module comprising:
a carrier substrate comprising a connector; and
a memory chip attached to the carrier substrate;
wherein the memory chip comprises an electronic circuit, the electronic circuit comprising:
a input receiving at least one input information item, the at least one input information item representing received encoded chip select information,
a value modifier providing modified encoded chip select information based on the received encoded chip select information,
wherein the value modifier processes at least one information item of the received encoded chip select information to obtain an information item of the modified encoded chip select information,
an output outputting at least one output information item, the output information item representing the modified encoded chip select information, and
a circuit selection determinator generating a circuit selection signal on the basis of the received encoded chip select information or the modified encoded chip select information.

30. The memory module of claim 29, further comprising at least one stack of at least two identical memory chips, wherein the at least one stack is attached to the carrier substrate;
wherein each of the at least two identical memory chips comprises a corresponding electronic circuit, each of the corresponding electronic circuits comprising:
an input receiving at least one input information item, the at least one input information item representing received encoded chip select information,
a value modifier providing modified encoded chip select information based on the received encoded chip select information, such that the modified encoded chip select information encodes a different value than the received encoded chip select information,
wherein the value modifier processes at least one information item of the received encoded chip select information to obtain an information item of the modified encoded chip select information,
an output outputting at least one output information item, the output information item representing the modified encoded chip select information, and
a circuit selection determinator generating a circuit selection signal based on whether the received encoded chip select information or the modified encoded chip select information takes a predetermined reference value;
wherein each of the at least two memory chips comprises a corresponding memory array coupled to the corresponding circuit selection determinator, such that the memory array is selected for access if the corresponding circuit selection signal is in an active state;
wherein at least one memory address contact of a connector is electrically connected to the input of a first chip of the at least two identical memory chips;
wherein the output of the electronic circuit of the first chip is connected to the input of the electronic circuit of a second chip of the at least two identical memory chips;
wherein the electronic circuits are configured such that in operation, the memory array of the first chip is activated for a different signal at the at least one address contact than the memory array of the second chip.

31. An electronic circuit, comprising:
means for receiving at least one input information item, the input information item representing received encoded chip select information;
means for processing the at least one input information item of the received encoded chip select information to obtain an information item of modified encoded chip select information;
means for outputting at least one output information item, the at least one output information item representing the modified encoded chip select information; and
means for generating a circuit select signal on the basis of the received encoded chip select information or the modified encoded chip select information.

32. The electronic circuit of claim 3 1, wherein the means for processing the at least one information item comprises means for logically inverting the at least one information item of the received encoded chip select information to obtain the modified encoded chip select information.

33. The electronic circuit of claim 31:
wherein the means for receiving at least one input information item comprises means for receiving a plurality of input information items, the input information items representing a received encoded chip select information;
wherein the means for processing the at least one information item comprises means for combining at least two information items of the received encoded chip select information to obtain an information item of modified encoded chip select information, such that the modified encoded chip select information encodes a different value than the received encoded chip select information; and
wherein the means for outputting at least one output information item comprises means for outputting a plurality of output information items, the output information items representing the modified encoded chip select information.

34. The electronic circuit of claim 3 1, further comprising means for storing information and for allowing an access to the stored information based on a state of the circuit select signal.

35. The electronic circuit of claim 33, wherein the received encoded chip select information represents an encoded input value, wherein the means for combining at least two information items comprises means for increasing or decreasing the encoded input value by a predetermined value to obtain an encoded output value, and wherein the encoded output value forms the modified encoded chip select information.

36. The electronic circuit of claim 35, wherein the means for generating the circuit selection signal comprises means for generating the circuit select signal based on at least one carry signal provided by the means for increasing or decreasing the encoded input signal.

37. A method for selecting an electronic circuit on the basis of at least one information item representing received encoded chip select information, the method comprising:
providing modified encoded chip select information by processing at least one information item of the received encoded chip select information to obtain an information item of the modified encoded chip select information,
wherein the modified encoded chip select information encodes a different value than the received encoded chip select information; and
generating a first circuit selection signal on the basis of the received encoded chip select information or the modified encoded chip select information.

38. The method of claim 37, wherein processing at least one information item of the received encoded chip select information comprises inverting the information item of the received encoded chip select information.

39. The method of claim 37, wherein providing modified encoded chip select information comprises combining at least two information items of the received encoded chip select information to obtain an information item of the modified encoded chip select information.

40. The method of claim 39, further comprising:
receiving a plurality of information items representing the modified encoded chip select information;
providing twice-modified encoded chip select information by combining at least two information items of the received modified encoded chip select information to obtain an information item of the twice-modified encoded chip select information,
wherein the twice-modified encoded chip select information encodes a different value than the received encoded chip select information; and
generating a second circuit selection signal in dependence on whether the modified encoded chip select information or the twice-modified encoded chip select information takes a predetermined value;
wherein the first circuit selection signal is active for a different combination of information items of the originally received encoded select information than the second circuit selection signal.

41. The method of claim 39, further comprising receiving at least two address bits of binary encoded address information from a microprocessor or memory controller as the received encoded chip select information.

42. The method of claim 39, further comprising converting one-out-of-n encoded chip select information into a binary encoded format to obtain encoded chip select information in a binary encoded format.

43. A computer program for selecting an electronic circuit on the basis of at least one information item representing received encoded chip selection information, the computer program including software to be fun on a computer, the software:
to provide modified encoded chip select information by processing at least one information item of received encoded chip select information to obtain an information item of the modified encoded chip select information, wherein the modified chip select information encodes a different value than the received encoded chip select information; and
to generate a circuit selection signal in dependence on whether the received encoded chip select information or the modified encoded chip select information takes a predetermined value.

44. An electronic circuit, comprising:
an input configured to receive a plurality of input information items, the input information items representing received encoded chip select information;
a value modifier configured to provide a modified encoded chip select information based on the received encoded chip select information, such that the modified encoded chip select information encodes a different value than the received encoded chip select information,
wherein the value modifier is configured to combine at least two information items of the received encoded chip select information to obtain an information item of the modified encoded chip select information;
an output for outputting a plurality of output information items, the output information items representing the modified encoded chip select information; and
a circuit selection determinator configured to generate a circuit selection signal on the basis of the received encoded chip select information or the modified encoded chip select information;
wherein the electronic circuit comprises a memory array;
wherein a predetermined reference value is independent from any memory-access-address information;
wherein the received encoded chip select information is a binary encoded input value;
wherein the value modifier comprises an adder configured to add a predetermined value to the binary encoded input value to obtain a binary encoded output value, or a subtractor configured to subtract the predetermined value from the binary encoded input value to obtain a binary encoded output value;
wherein the binary encoded output value forms the modified encoded chip select information; and
wherein the circuit selection determinator is configured to generate the circuit selection signal based on at least one carry signal provided by the value modifier when adding the predetermined value to the binary encoded input value or when subtracting the predetermined value from the binary encoded input value.
